(19) United States
(12) Patent Application Publication
(10) Pub. No.: US 2009/0320697 A1
(43) Pub. Date: Dec. 31, 2009

(54) CONTINUOUS PRESS AND METHOD FOR MANUFACTURING COMPOSITE MATERIALS WITH PROGRESSIVE SYMMETRICAL PRESSURE

(76) Inventor: Mario Antonio Rago, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/492,677

(22) Filed: Jun. 26, 2009

Related U.S. Application Data
(60) Provisional application No. 61/076,336, filed on Jun. 27, 2008.

(51) Int. Cl. B30B 5/06

(52) U.S. Cl. 100/35; 100/153

(57) ABSTRACT

The present invention is a continuous pressing system and method for the manufacture of composite materials. The press system incorporates at least one belt opposingly positioned with a surface, that may be another at least one belt. The opposing belt and surface are angled in relation to each other to produce symmetrical pressure upon materials fed between the opposing belt and surface. The belt may be driven by a driving means that causes the belt to rotate in a specific direction and thereby move the material between the belt and surface for the whole length that the belt and surface oppose each other. The symmetrical pressure upon the material produces a compress material.

This application claims the benefit of U.S. Provisional Patent Application Ser. No. 61/076,336 filed Jun. 27, 2008.

### FIELD OF INVENTION

This invention relates in general to the field of continuous pressing systems and methods for producing composite materials. This invention further relates to a pressing system and method that applies progressive symmetrical pressure in the process of manufacturing composite materials, including laminate.

### BACKGROUND OF THE INVENTION

Press systems and methods have been created to address the unique hurdles of manufacturing composite materials over time. The methods and machines created to undertake this task have incorporated several features.

U.S. Pat. No. 3,994,771 discloses a papermaking machine that creates two-ply paper products. The machine employs rollers positioned outside of the area where the stack (in this case pulp) meets the belts which is the point where pressing occurs. One ply of the paper pulp substrate is passed around each of the rollers positioned outside of the pressing area, where each ply meets and is merged. Thus, the rollers are beyond the pressing area, but they are in contact with substrate nonetheless.

U.S. Pat. No. 4,794,855 discloses a continuous press machine that includes a pressure applying device for urging a pair of opposed endless belts toward each other to compress a sheet-like material passing therebetween. The machine disclosed by this patent is applicable to the creation of materials other than paper through a pressing process. Moreover, it involves a continuous pressing application.

U.S. Pat. No. 5,342,566 discloses a method for producing gypsum board through a compression process, utilizing driving rollers positioned outside the area where the stack is compressed. These rollers drive a belt that is an element of the compression stage. Furthermore, the top belt is angled to aid in the compression of the substrate as it approaches the pressing belt.

U.S. Pat. No. 5,112,209 discloses a double-band press wherein pressure on the mat being fed through the machine is increased so rapidly as soon as the mat comes into contact with the heat-transfer surface that the outer areas of the mat harden under the great pressure, but the heat does not penetrate into the interior of the mat. The press may be configured so that the driving rollers are outside the area where the stack comes into contact with the belts, and the upper and lower belts are angled at the point where the stack is initially compressed.

U.S. Pat. No. 5,612,125 discloses a prepeg obtained by stretching a material and a machine for achieving this. As shown in FIG. 1 pad rollers rotatable around their corresponding central shafts are utilized. Platens apply pressure to the pad rollers in a manner that permits the rollers to remain rotatable.

U.S. Pat. No. 5,979,145 discloses an apparatus for compressing compressible materials. The compression is carried out continuously between parallel plates which come closer together as they advance.

U.S. Pat. No. 6,439,113 discloses a method for producing pressed board utilizing driving rollers positioned outside the area where the stack is compressed. The method further employs angled belts (top and bottom) to aid in the compression stage.

The prior art includes continuous presses which manufacture LVL in one step. That is to say, a single grouping of veneers (that make up one sheet of LVL) usually up to 15 layers of veneer, are fed directly into a hot continuous press. The production rate is fixed for this type of operation and is limited to the length and feed rate.

The prior art creates several problems for pressing systems. In particular the distribution of pressure is inconsistent, which creates non-uniform distribution of adhesives, when they are utilized, which has effect upon the cost of production. Furthermore, the systems utilize a significant amount of power to operate. Moreover, the replacement of integral elements, such as belts can be costly, as the entire element must be replaced when one section of it wears out.

### SUMMARY OF THE INVENTION

In one aspect, the present disclosure relates to a continuous press system to produce compressed stack output comprising: a power source; a stack; one or more belts wherein at least one belt is opposingly positioned in relation to a surface in a manner whereby the distance between the at least one belt and the surface varies and the at least one belt and surface are angled are in relation to each other to facilitate symmetrical pressure upon the stack as it is fed between the at least one belt and the surface to compress the stack; and two or more driving means driven by the power source to drive the at least one belt and cause the stack to pass between the at least one belt and surface for the length of the area where the at least one belt and surface are opposingly positioned to produce compressed stack output.

In another aspect, the present disclosure relates to a continuous press system to produce compressed stack output comprising: a power source; a stack; one or more belts wherein at least one upper belt is opposingly positioned with at least one lower belt in a manner whereby the distance between the at least one upper belt and the at least one lower belt varies and the at least one upper belt and the at least one lower belt are angled in relation to each other to facilitate symmetrical pressure upon the stack as it is fed between the at least one upper belt and the at least one lower belt to compress the stack; and at least one synchronization means driven by the power source to drive the at least one upper belt and the at least one lower belt and cause the stack to pass between the at least one upper belt and the at least one lower belt for the length of the area where the at least one upper belt and the at least one lower belt are opposingly positioned to produce the compressed stack output.

In yet another aspect, the present disclosure relates to a method of compressing a stack through symmetrical pressure comprising the steps of: inputting a stack between at least one belt and a surface opposingly positioned and relationally angled to produce symmetrical pressure where the distance between the at least one belt and surface is greatest; directing the stack between the length of the at least one belt and surface by way of movement of the at least one belt, achieved by the application of a power source to a driving means, to move the stack between the belt and surface and exert increasing pressure upon the stack due to the narrowing angle of the at least one belt and surface; and retrieving the compressed output stack when it exits the length of the opposing at least one belt and surface.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a side-view cross-section of the through segment of the press system.

FIG. 2 is a front-end cross-section of the through segment of the press system.

FIG. 3 is a cross-section of the through segment of the press system.

FIG. 4 is a side-view of the press system.

FIG. 5 is a side-view of the compression segment of the press system.

FIG. 6 is a side-view of the compression angled-belt segment of a press.

FIG. 7 is a side-view of the compression angled-belt in-feed segment of the press system.

FIG. 8 is a side-view of the compression angled-belt segment of the press system.

FIG. 9 is a side-view of the compression angled-belt in-feed segment of the press system.

FIG. 10 is a side-view of the symmetrical compression linkages.

FIG. 11 is a side view of a symmetrical compression mechanism.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention consists of a continuous press application, system and method, utilizing pressing and conveying surfaces in combination so as to provide symmetrical pressure upon materials passed through the press. The output from the pressing system is compressed material, such as composite materials. The present invention is a method and apparatus for manufacturing compressed materials.

Some terms that will be utilized to describe to the present invention bear definition. For example, the term “belt” may mean a segmented belt, a conveyor type belt, or a solid or continuous belt. A belt may be formed from a variety of materials, such as, for example a metallic or non metallic materials. Additionally, the term “stack” refers to any material that is fed into the press, and therefore includes any product, composite, laminate, semi-fluid, or other material and/or streams of material that may be fed into the press system of the present invention.

The present invention may be a continuous press that incorporates at least one belt and at least one surface. The at least one belt may be a segmented belt. The belt segments may combine to form a virtually flat surface. The at least one belt and the surface may be positioned in an opposing manner. The surface may comprise one or more belts, or may be another type of surface. Stack may be fed into the press between the opposed belt and surface. The belt and surface may be angled in relation to each other to facilitate compression of the stack. In particular the angle of the belt and surface may produce symmetrical pressure to be exerted upon the stack fed between the belt and surface. One or more synchronization means or driving means, such as one or more driving rollers may drive the at least one belt. The one or more driving rollers may be positioned in a manner whereby the rollers do not contact the stack. Elements of the present invention may be configured to exert symmetrical pressure on the stack for the purpose of pressing the stack to create an output that is a compressed material. A skilled reader will recognize that other embodiments of the present invention are also possible.

The pressing system of the present invention offers several features that provide benefits over the prior art. The present invention incorporates features that overcome industry hurdles. Some of these are discussed below.

In one embodiment of the present invention, one or more belts may be utilized and these belts may be segmented belts formed of two or more belt segments. The belt segments may combine to form a near flat surface (a straight line cord) where the belt segments come into contact with the stack. A benefit of a segmented belt is that if one or more belt segments wear out these segments may be replaced individually. Or if one portion of the belt needs to be fixed, the affected segments may be detached from the rest of the belt. The segmented belt of the present invention can provide cost-saving benefits for machine maintenance and upkeep.

In another embodiment of the present invention, driving rollers may be applied to drive the belt and these may be positioned on the outer edges of the belt, such that the driving rollers do not come into contact with the stack. In another embodiment of the present invention, the belt segments may be connected to a drive chain in a manner whereby every other link is connected to a segment. A benefit of this connection method is that it may aid in keeping belt segments from jamming. In particular this configuration avoids jamming when the belt segments move around the driving rollers.

In yet another embodiment of the present invention, two belts may be positioned in an opposing manner and the stack may be passed through the belts. Alternatively, one belt may be positioned opposing to a surface area and that stack may pass between the belt and the opposing surface. The opposing belts, or the opposing belt and surface, may be angled at the point where the stack first comes into contact with the belt. A benefit of this embodiment of the present invention is that it may create a more effective compression means than prior art.

In still another embodiment of the present invention, the elements of the press may be configured to exert symmetrical pressure upon the stack. A benefit of this embodiment of the present invention is that the symmetrical pressure may cause less electricity or power to be required to run the press system than is required by other known presses of the prior art.

In another embodiment of the present invention, an equal distribution of adhesive may be achieved throughout the composite material through the symmetrical pressure achieved by the press system. This embodiment may create two benefits: the amount of adhesive applied may be accurately predicted; and it may be a cost-effective measure, as less adhesive may be required due to equal distribution.

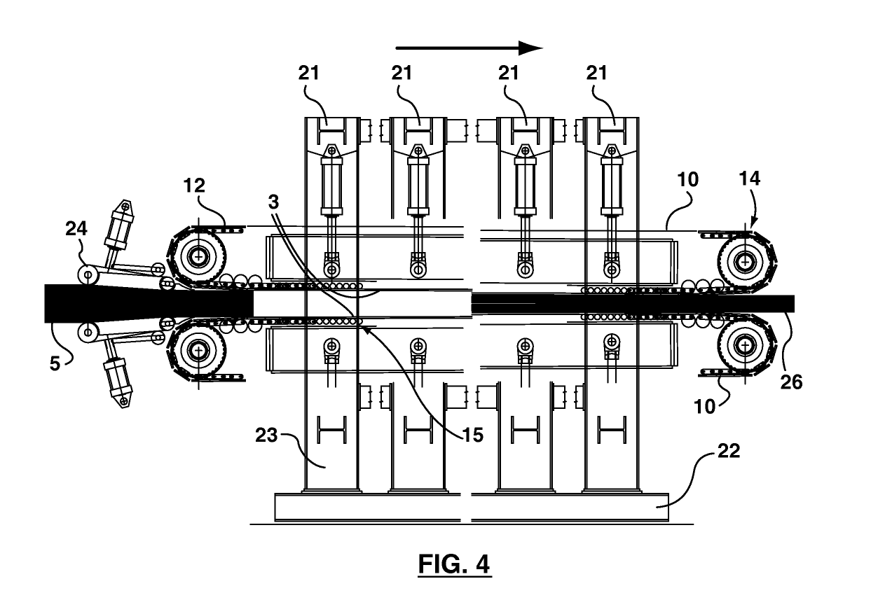

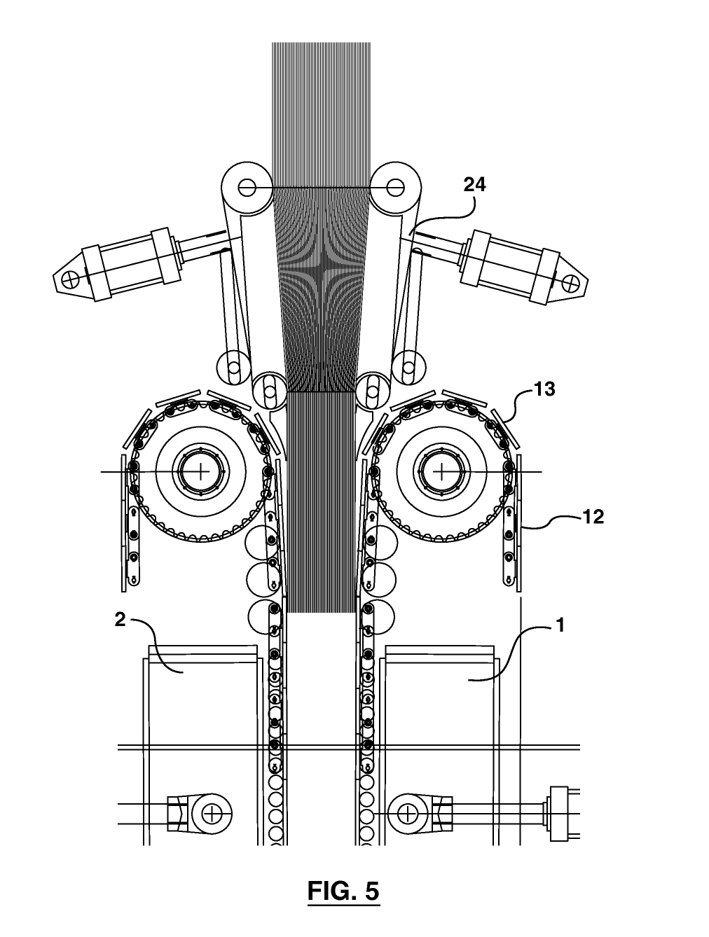

In one embodiment of the present invention, one or more driving rollers may be connected to a power source and may be utilized to drive one or more belts. As shown in FIG. 4, the driving rollers 14 may be positioned at the outer edges of the belt so as to avoid contact with the substrate stack 5. The pressing elements may generally be configured so as to exert symmetrical compression upon the stack. Additionally, as shown in FIG. 5, the belt may be segmented and the belt segments 13 may be formed so that they can combine in an integrated manner to form a near flat surface 12. The flat surface may be utilized where the belt comes into contact with the stack in particular.

One embodiment of the present invention may incorporate a drive chain. The belt segments may be removably attachable to the drive chain. In such an embodiment of the present invention, not every link of the drive chain need be attached to a belt segment. For example, in one embodiment of the present invention, every other link of the drive chain may be attached to a belt segment. Such a connection method may diminish the capacity for belt segments to jam. Jamming may occur particularly at the point where the belt moves around a driving roller. A skilled reader will recognize that many attachments of the chain links to the belt segments may be incorporated in the present invention. The press system of the present invention may further incorporate sprockets to facilitate driving of the chain. The driving of the chain through the incorporation of sprockets may cause the belt segments, which are attached to the chain, to be driven as well.

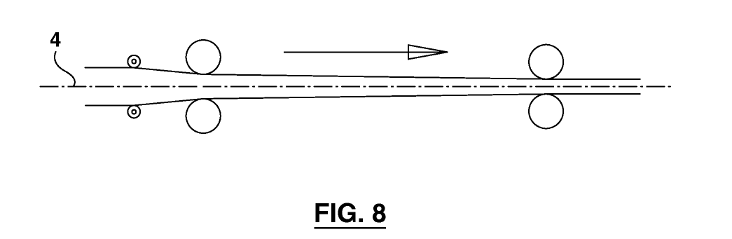

In one embodiment of the present invention, as shown in FIG. 4, the pressing section of the press system may incorporate at least one belt 10 opposingly 3 positioned with another surface. The surface may be one or more belts. As shown in FIGS. 4, 5, and 8, the surface and belt may both be angled in relation to each other in a manner whereby the distance between the belt and surface diminishes. The stack 5 may be passed between the opposing surface and belt, as shown in FIG. 4, and may be compressed as it travels along the length of the opposing belt and surface. The output stack 26 may be a compressed output. Alternatively, the surface may consist of a one or more additional belts positioned at an angle to one or more opposing belts.

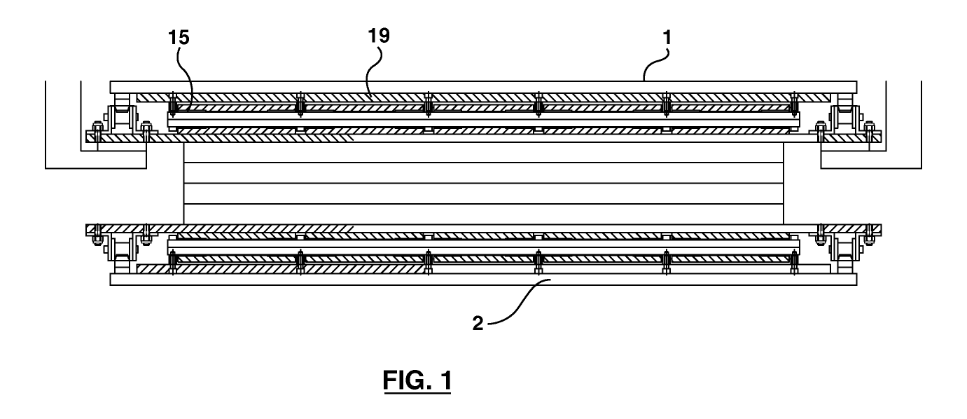

In another embodiment of the present invention, as shown in FIG. 5, platens 1 and 2 may be utilized to apply pressure to the belt segments 13 to facilitate, or enhance, compression of the stack. Platens may be situated so as to apply pressure to the side of the belt that is internal to the pressing system, meaning the side that is not directly opposing another belt segment or a surface. Platens 1 may contact the side of the belt that does not contact the stack, as shown in FIG. 1. In embodiments of the present invention, as shown in FIGS. 1 through 3, platens 1 and 2 may be utilized to apply pressure to each of the opposing belts. Platens may also be positioned to exert pressure to both an opposing belt and surface. However, a person skilled in the art will recognize that platens may also be positioned in other manners, such as, for example so as to apply pressure to only one of the opposing belts, or the opposing belt or surface.

In yet another embodiment of the present invention, as shown in FIG. 4, pad rollers 15 may be positioned between the belt segments and the platens or bolsters. The pad rollers may function so as to reduce the friction between the platen and the belt segments, or surface, when the platen exerts pressure thereupon. The pad rollers may remain fixed but rotatable in the press system, so as to continuously be positioned in the same location in the length of the press system, and consequently will not progress with any belt segments as the belt segments are driven in a particular direction. The rollers may be stationary in relation to the belt segments, but rotatable upon an axis as the belt segments move. As platens or bolsters are utilized to apply pressure, the platens or bolsters may contact the pad rollers directly. Such pressure may create subsequent pressure upon the belt segment as the rollers meet the belt, for the purpose of compressing the stack.

In one embodiment of the present invention there may be multiple pad rollers in contact with a belt segment at one time, such as, for example three pad rollers. Furthermore, the pad rollers may be a consistent size, for example, such as 2½ (two and a half) inches in diameter, and may be a consistent distance from each other, for example, such as 3 (three) inches apart.

In another embodiment of the present invention, two continuous presses may be applied in the pressing system. The first press may provide a pre-compression function, and the second machine may provide an additional compression stage. Alternatively, additional press apparatus may be aligned with the press system, such as, for example a pre-press or a tack-up apparatus.

In yet another embodiment of the present invention, the opposing belt and surface, or two or more opposing belts, may be angled towards each other prior to the point where the stack first comes into contact with the one or more belts. The angle of the opposing belt and surface, or two or more opposing belts, may be comprised so as to create a more effective compression means.

A stack may initially come into contact with the one or more belts where the distance between the opposing belts, or opposing belt and surface, is greatest as the belts, or belt and surface, are angled away from each other. The stack will be pulled through the length of space where the belts, or belt and surface, remain opposite one another. Pressure imposed upon the stack as it travels along this length may cause the stack to compress.

There are several advantages to the present invention. These advantages include configuration and inclusion of particular elements, some of which are discussed above. Additional advantages that are outputs of the system and method may also be achieved through embodiments of the present invention. In particular, equal distribution of adhesive may be achieved throughout the composite material. This can be a cost-effective measure as less adhesive may be required and the amount of adhesive required to be applied can be accurately predicted. Additionally, the press system may be configured to achieve an even distribution of forces. This aspect can mean that less electricity or power may be required to run the press system than is required by other presses of the prior art.

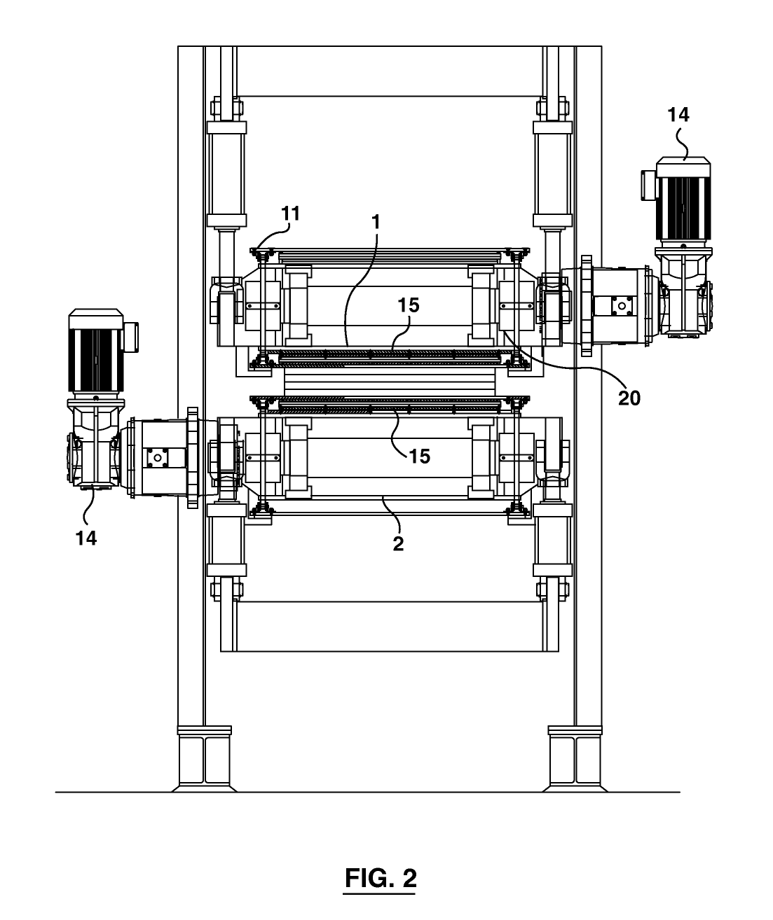

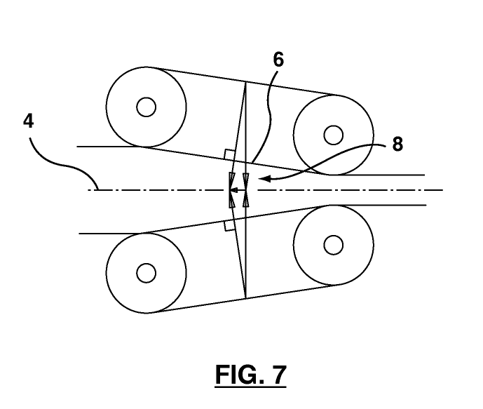

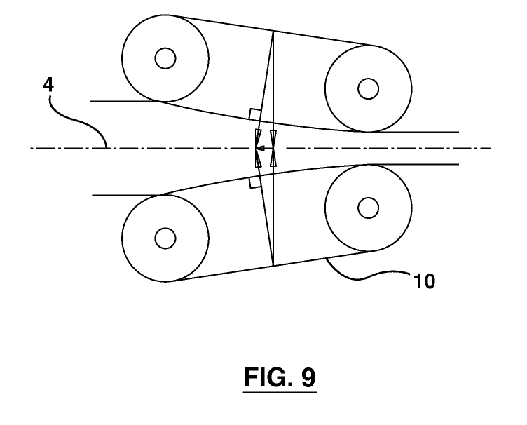

As shown in FIG. 1 through FIG. 5 and FIG. 7 through FIG. 11, embodiments of the present invention may include several key elements. As shown in FIG. 1 and FIG. 2, the upper 1 and lower 2 platens or bolsters may be positioned opposite each other in a symmetrical manner throughout the length of the press system. That is to say that the platens or bolsters may be positioned so as to be rendered virtually mirror images of each other when compared to an imaginary center line 4 which runs horizontally through the product being pressed, as shown in FIGS. 7 through 9. A skilled reader will recognize that the position of the platens or bolsters may be different for particular embodiments of the invention, such as, for example being parallel to each other or converging in a straight line or, as shown in FIG. 7, converging in an arc or parabolic shape 6 as progressing through in the direction of product movement or flow.

Existing continuous presses of the prior art, as shown in FIG. 7, generally include a lower platen positioned on a horizontal plane and an upper platen, that generally conforms to a shape that gradually applies pressure in varying degrees to achieve the desired thickness and density (compaction) from entry to exit of the press.

An advantage of an embodiment of the present invention, as shown in FIG. 7, is that the introduction of symmetrical pressure (geometry) applied as forces 8 transmitted into the product may also be symmetrical or equalized when looking at the cross-section of the product. In addition, the forces required to compact the product and forces reacted by the press system of the present invention may also be equalized or symmetrical in the upper and lower sections of the press.

Generally, when comparing the power requirements and size of components of prior art systems having non-symmetrical pressing, with the symmetrical pressing system of the present invention, the symmetrical configuration will be shown to offer notable power savings.

In press system embodiments that have very low compaction ratios there will be less impact of power savings. In high compression press system embodiments, such as, for example ratio laminate streams, balanced forces are critical as they ensure that specific pressure on the laminate is equally distributed throughout the composition, as shown in FIG. 7. Such equal pressure distribution may ensure that any adhesive being used in the manufacturing process, applied between each laminate element may be acted upon in a balanced way. The result may be an even distribution of adhesive.

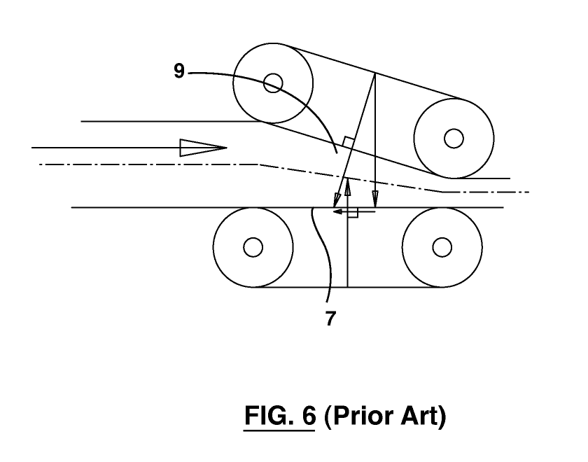

In an unsymmetrical pressure application, the lower elements in a laminate composition can have different applied loads than the upper layers. Typically there will be increased shear or thrust loads transmitted back through the product and equipment with unbalanced pressure application. Such a prior art system, having unbalanced pressure application, is shown in FIG. 6. For a given laminate stream and in particular when dealing with high compaction ratios, the shear forces transmitted into the laminate may be substantially reduced due to the application of symmetrical pressure of the present invention in comparison to prior art systems having either one horizontal plane and one incline plane, or one horizontal plane and one conforming pressure plane 9.

Another embodiment of the present invention may include a mechanism by which pressure is applied to the product during conveying of the product through the press. In this embodiment, as shown in FIG. 4, there may be two symmetrically opposing belts 10 which may each be made up of a two strand chain towing system with discrete attached belt segments that may form a continuous flat surface. The chain may include one or more chain links. The belt segments may be fastened to the chain links, in a fixed or removeable manner, so that a belt segment attached to a chain link virtually becomes a part of the chain link. Threaded fasteners and/or machined nests 11, as shown in FIG. 2, may be utilized to achieve the attachment of belt segments to chain links. Due to the attachment tension forces may be directly transmitted into the chain from the belt segments. When positioned on a horizontal plane the belt segments may form a tight grouping to achieve a flat surface 12 as shown in FIG. 5. When the belt segments are on a horizontal plane and in contact, the gaps between the belt segments may be as close to zero as possible. The close proximity of the belt segments may minimize the potential for the stack that is being pressed to squeeze through the gaps between belt segments.

The belt segments may be attached to every other chain link of the chain. This form of attachment may facilitate the geometrical separation as the segments rotate around the end sprockets which drive the chain, as shown in FIG. 5. If the segments are attached to every link, mechanical interference may occur as the segments rotate around an arc. A skilled reader will recognize that other manners of attachment are possible.

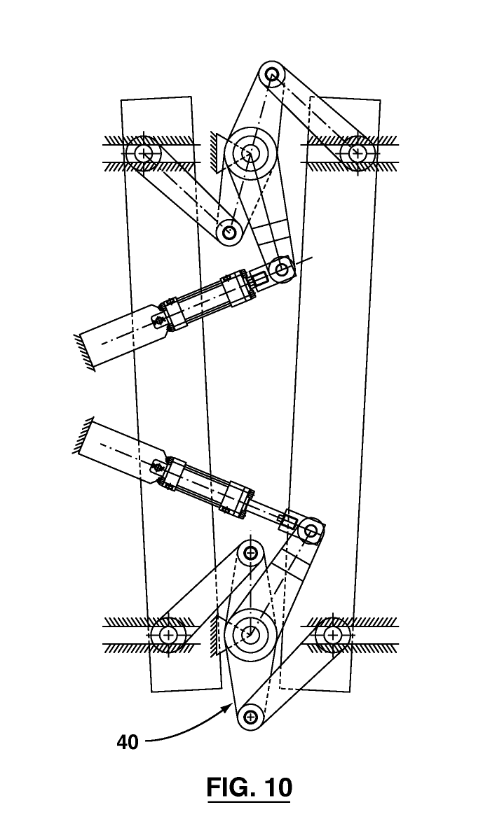

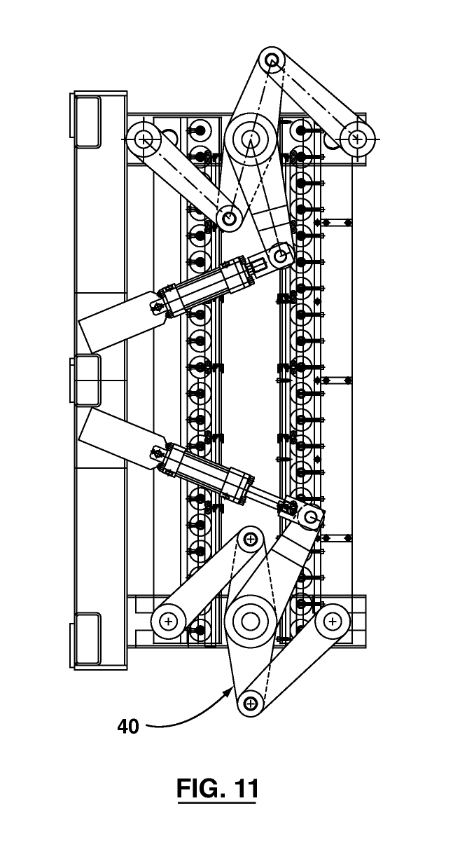

In one embodiment of the present invention, the mechanism for symmetrical movement may be achieved through linkages, as shown in FIG. 10 and FIG. 11. Hydraulic or mechanical actuators may be connected to the linkages 40. Such actuators may facilitate extension or retraction of the actuator that may cause rotary motion in the linkage arm which may rotate around a fixed point. Secondary linkages attached to the rotating arm may further transmit the rotary motion back to linear vertical motion. The vertical motion may be achieved by stationary slide or cam ways. These cam ways can force the secondary linkages to travel only in the vertical direction.

To achieve symmetrical pressure, pressure sensors in the case of hydraulic actuators may be connected in-line and may have the capacity to register the various clamping forces at numerous compression stages. For example, as the laminate stack is compressed, measurement of height, and/or other measurements, may be taken along with a measurement of the corresponding pressure value. At the ideal conditions the forces required to move the product through the press may be determined based upon the measurements.

In one embodiment of the present invention, each of the one or more opposing conveyor belts, or the belt opposing a surface, may be driven by one or more independent drive motors that provide a power source. Such one or more drive motors may be electric, electro hydraulic, or any other type of motor that achieves the function of this invention. The drive motors may be located at the exit end of the belt, so as to achieve a pulling action in the direction of flow as the stack progresses through the length of the press system.

In one embodiment one drive motor may be a master and another drive motor may be a slave. The speed of the opposing belts may be synchronized, or near to synchronized, by a synchronization means 14, as shown in FIGS. 4 and 2, such as, for example electronically or mechanically, to ensure no relative motion (unsynchronized motion) between these two moving surfaces. The symmetry of the surfaces can also reduce or eliminate relative movement between the upper and lower layers of the stack 14, such as for example relative movement between the upper and lower layers of a laminate composition. Symmetrical loading may imply symmetrical power requirements, (to simplicity process, the static weight of the stack stream and dead loads of the chain may be neglected for power calculations since they are insignificant when compared to the power required to overcome static and rolling friction between components of the present invention).

In one embodiment of the present invention, as the belt segments travel through the press system they may be supported by a matrix of pad rollers 15, as shown in FIG. 2. The pad rollers may be arranged in a manner that minimizes deflection and friction so as to ensure that the belt segment is fully supported across the width of the press system and perpendicular to the direction of motion or flow. The pad rollers may be set at center distances to maximize support and may be of a maximum diameter and length to ensure that pressure distribution into the belt segments is uniform. The pad rollers may further be equipped with low friction permanently lubricated bronze bushings and may be of a length and diameter to absorb the required loads and rotational speeds that the laminating process requires. The pad roller material and the belt segment material can be metal and of compatible composition so as to facilitate minimized wear and maximum durability. Alternatively, the pad roller material and belt segment material may be formed of the same or dissimilar materials, such as, for example the pad rollers and belt segments may be manufactured from wear resistant carbon or alloy steel. A skilled reader will recognize that other materials may be utilized to form the pad rollers and belt segments.

In one embodiment of the present invention, as shown in FIG. 1, the pad roller matrix may be mounted on solid steel plates of a uniform size that are capable of facilitating easy removal of the matrix plate and exchange 19. The useful life of the rollers and bearings may be extended if a rotational program is implemented. The roller matrix at the high pressure end of the press system, being the area where the stack exits the press system, may be removed periodically and inserted at the low pressure end of the press system, being the area where the stack enters the press system. The remaining roller matrices may be advanced one step. Over an extended period of operating time all pad rollers may have been exposed to the same loading conditions. A skilled reader will recognize that other means of prolonging the life of the pad rollers and press system may be applied.

In another embodiment of the present invention, the pad roller matrices may be mounted to a bolster. In this embodiment there may be at least two bolsters, an upper bolster and a lower bolster. The upper and lower bolsters may be positioned so as to virtually present as mirror images of one another about the neutral axis or imaginary center line of the area of the press system between the opposing belts, or opposing belt and surface, wherein the stack passes. The bolsters can be formed of solid steel construction or other similar material. Moreover, the bolsters may be formed of several constructions, such as of hollow or of box construction. Additionally, the bolsters can be made of discrete segments that rigidly or loosely fastened together, or of a single piece. A skilled reader will recognize the variety of bolsters that may be utilized in the present invention.

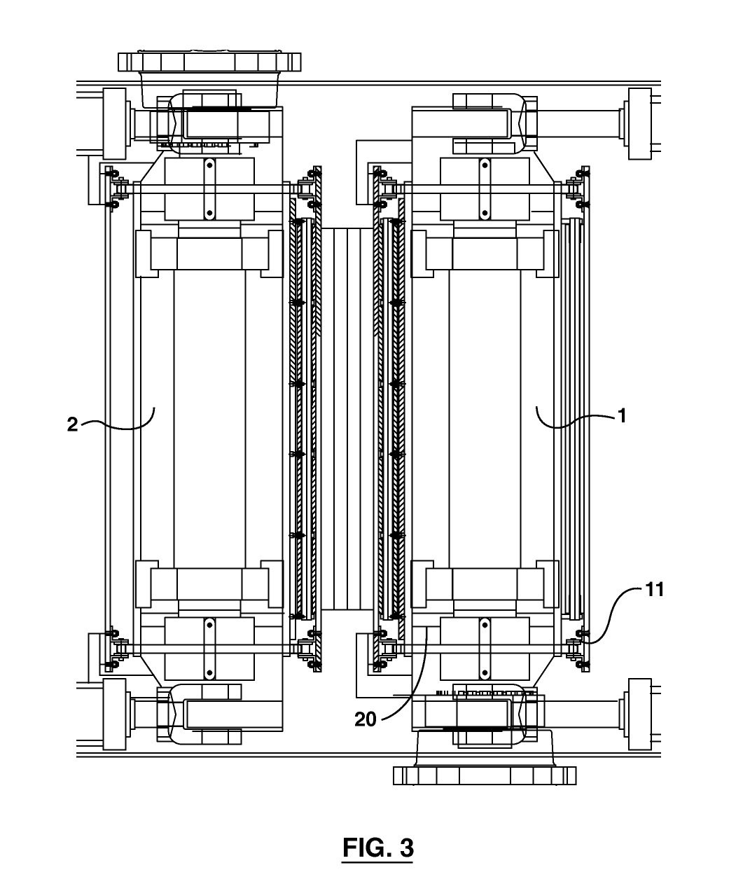

The sides or opposed vertical surfaces of the bolsters may be used to attach one or more electro-mechanical or hydraulic actuators 20, as shown in FIGS. 2 and 3. The actuators may facilitate the positioning and load application or reaction forces required to compact the stack, such as, for example a laminate or composite stream. Varying pressure or position values can be achieved by strategically locating actuators along the length of each side of the bolsters 21, as shown in FIG. 4. The size capacity and quantity of the actuators is process dependent and may be dictated by features such as the compression ratio, specific pressure and/or width of the product being compacted. The actuators and bolsters may be supported and guided by an outer structure that can be manufactured as elements and mounted to a common base 22. These structural elements 23 can occur in the same frequency as the actuators and may be used to react and support the equal and opposite forces as pressure is applied to the stack.

In one embodiment of the present invention, the pressure or force applied to the stack may be controlled by electro-mechanical sensors that determine, either by pressure or positional feedback, what the determinant force or pressure to be applied should be. The process of compaction may be dictated by thickness or specific pressure or a combination of both parameters to achieve the desired final density and thickness of the output stack. A skilled reader will recognize that one or more sensors may be attached to the press system at positions where the required feedback may be acquired.

Another embodiment of the present invention, may include a pre-compressor positioned at the in-feed of the press system of the present invention. As shown in FIG. 4, the in-feed 24 may be positioned being where the stack enters the press system. The pre-compressor may have similarities to the press of the present invention, and may be a second press that is an embodiment of the present invention. The multiple presses may for another embodiment of the press system.

In an embodiment of the present invention, configured for pressing laminate stream stack to create a stack output that is Laminated Veneer Lumber (LVL) several considerations may be required. For example, in LVL there can be a considerable volume of empty space between veneers. This is due to the natural curl that occurs in wood veneers as moisture is drawn out. When these sheets of veneer are stacked there is an inherent air volume between them. In order to maximize the length of time the laminate stream is exposed to the required pressure application, given a finite physical space in which this operation must take place, it may be necessary to pre-compact the stream. The pre-compactor can be an extension of the entry to the continuous press and may generally apply similar geometry to that of the press of the present invention. The pre-compactor may become part of the press system of the present invention, wherein the pre-compactor is one section of the press system and a main press, that is an embodiment of the present invention as described above, is a second section. Separate drivers and actuators may allow the pre-compactor process to operate independently of the main press, alternatively the drivers and actuators may be shared between the press system sections. The pre-compression may be achieved symmetrically about the imaginary center line of the laminate or composite stream. A skilled reader will recognize that other press sections may also be added to the press system of the present invention.

A skilled reader will recognize that it may be possible to apply of a heat source to the press system of the present invention. A heat source may facilitate curing or activation of resins, glues or adhesives to the system and method of the present invention. A skilled reader will recognize that a heat source may be added to the present invention in many manners, such as, for example by means of radio frequency heating or micro wave technology, or other manners. A skilled reader will further recognize that the integration of a heat source with the present invention may be achieved in a known manner, or in other manners specific to the configuration of the present invention.

In one embodiment of the present invention, the system and method may be configured to produce a system and method for the pre-pressing or tack-up stage. For example, such a embodiment of the present invention may be applied for manufacturing LVL at near or ambient conditions and in a two part operation. Such an embodiment may first incorporate a pre-pressing operation stage. The pre-pressing operation may be achieved in a discrete, step press operation whereby a stack of veneer may be positioned between two horizontally opposed flat surfaces and an even pressure is applied vertically to initiate the adhesive (glue) process. Adhesive (which was previously applied between layers) may be pressure and heat sensitive. In the pre-press operation stage, the adhesive may tack-up and consolidate the layers of veneer to form a solid mass, void of air or space. Another hot-pressing stage of an LVL manufacturing system and method may involve the consolidated ribbons of LVL. The consolidated ribbons of LVL may be positioned between another set of horizontally opposed heated plates. Pressure may be applied evenly across the surface of the plates for a specified time and at a specified temperature to allow the glue to cure. The stack output may be a rigid solid mass that in all aspects meets or exceeds the strength of dimensional lumber. Pre-pressing may occur at ambient temperatures and hot-pressing may occur at elevated temperatures, such as, for example 350 degrees Fahrenheit. A skilled reader will recognize that this embodiment may be applied to stack other than LVL.

An embodiment of the present invention may be configured to provide a pre-press for LVL or other composite sheet laminations that contain multiple discrete layers. For example, a single composite LVL sheet may contain approximately fifteen discrete layers. Each layer may have once been a single discrete sheet itself. However, through the pressing process the layers are joined into a new stack output composite. For the purpose of this document, the composite sheet is referenced as a single sheet.

An embodiment of the present invention may facilitate the pre-pressing of two or more composite sheets simultaneously, and typically four or more can be pressed. The impact of symmetrical loading, and forces transmitted into the veneer become more apparent and critical in this embodiment, as compared to compacting of few layers which tend to approach the condition of having laminates between two parallel flat pressing, due to low compaction ratio the angle of the bolster from entry to exit may be negligible and can be considered flat and parallel.

By pre-pressing multi streams of LVL, an existing step press operation can dramatically increase output and/or production rate and at the same time minimize the capital investment to do so.

Conventional continuous hot presses are typically very costly to acquire run and maintain. Embodiments of the present invention may decrease the cost through measures such as the equal distribution of forces, which may require less power than other prior art presses, as well as cost-efficient features such as the even dispersing of adhesive, so that the amount of adhesive required may be decreased, and may be predictable.

It will be appreciated by those skilled in the art that other variations of the embodiments described herein may also be practiced without departing from the scope of the invention. For example, a variety of materials may be pressed in accordance with this invention, including materials that do not have distinct layers and are semi-fluid materials. The press of the present invention is capable of pressing materials of varying forms and performing this function at any stage of processing. The invention may be utilized in relation to any granular or shredded materials for the purpose of compaction of such materials by way of the pressing process of the present invention.

The invention may also be utilized to dewater materials, thereby removing excess water and moisture therefrom. In such an embodiment of the present invention, a belt may be utilized having gaps between the belt segments. Fluid extracted, wrung or otherwise removed from the materials through the pressing process may escape from the press through gaps between the belt segments. Materials processed to achieve dewatering may be of a variety of types, such as, for example waste materials or organic materials.

1. A continuous press system to produce compressed stack output comprising:
(a) a power source;
(b) a stack;
(c) one or more belts wherein at least one belt is opposingly positioned in relation to a surface in a manner whereby the distance between the at least one belt and the surface varies and the at least one belt and surface are angled are in relation to each other to facilitate symmetrical pressure upon the stack as it is fed between the at least one belt and the surface to compress the stack; and
(d) two or more driving means driven by the power source to drive the at least one belt and cause the stack to pass between the at least one belt and surface for the length of the area where the at least one belt and surface are opposingly positioned to produce compressed stack output.

2. The continuous press system of claim 1, wherein the surface that is at least one of the following:
(a) one or more continuous belts; or
(b) one or more segmented belts comprised of two or more belt segments that combine to form a virtually flat surface along a horizontal plane;
wherein the driving means is a synchronization means that virtually synchronizes the function of the at least one belt and the one or more belts of the press system.

3. The continuous press system of claim 1, wherein the at least one belt is a segmented belt comprising two or more belt segments that combine to form a virtually flat surface along a horizontal plane.

4. The continuous press system of claim 1, wherein one or more platens or bolsters apply pressure to the at least one belt, to the surface, or to the at least one belt and surface, to compress stack.

5. The continuous press system of claim 4, wherein one or more pad rollers are positioned between at least one of the following:
(a) the at least one belt and the one or more platens or bolsters; or
(b) the surface and the one or more platens or bolsters.

6. The continuous press system of claim 1, wherein one or more hydraulic or mechanical actuators facilitate travel of the at least one belt in a particular direction.

7. The continuous press system of claim 1, wherein one or more pressure sensors are utilized at various compression stages in the press system to calculate measurements and said calculations are applied to adjust the angle of the at least one belt in relation to the surface to facilitate the application of near-continuous symmetrical pressure to the stack to achieve a specific density or thickness of the compressed stack output.

8. The continuous press system of claim 1, wherein a laminate is fed with the stack and the symmetrical pressure upon the stack facilitates equal distribution of the laminate to the stack as the stack and laminate are fed between the at least one belt and the surface to compress the stack.

9. The continuous press system of claim 1, wherein the press system incorporates two or more presses positioned in a string so that the stack may progress through each of the two or more presses in succession.

10. A continuous press system of claim 9, wherein one or more press system components are positioned in a string with the one or more presses the components facilitating at least one of the following: a pre-pressing stage; or a tack-up stage.

11. A continuous press system to produce compressed stack output comprising:
(a) a power source;
(b) a stack;
(c) one or more belts wherein at least one upper belt is opposingly positioned with at least one lower belt in a manner whereby the distance between the at least one upper belt and the at least one lower belt varies and the at least one upper belt and the at least one lower belt are angled in relation to each other to facilitate symmetrical pressure upon the stack as it is fed between the at least one upper belt and the at least one lower belt to compress the stack; and
(d) at least one synchronization means driven by the power source to drive the at least one upper belt and the at least one lower belt and cause the stack to pass between the at least one upper belt and the at least one lower belt for the length of the area where the at least one upper belt and the at least one lower belt are opposingly positioned to produce the compressed stack output.

12. A continuous press system of claim 11, wherein the press system incorporates at least one of the following:
(a) the at least one upper belt is a segmented belt having two or more belt segments that combine to form a virtually flat surface along a horizontal plane; or
(b) the at least one lower belt is a segmented belt having two or more belt segments that combine to form a virtually flat surface along a horizontal plane.

13. A continuous press system of claim 12, wherein one or more drive chains having one or more links are attachable to the two or more belt segments and one or more hydraulic or mechanical actuators attachable to the one or more links of the one or more drive chains to facilitate travel of the one or more drive chains in a vertical direction.

14. A continuous press system of claim 11, wherein the synchronization means incorporates two or more driving rollers being positioned at the distant edges of the at least one upper belt, the at least one lower belt, or the at least one upper belt and the at least one lower belt, beyond where the at least one upper belt and at least one lower belt are opposingly positioned.

15. A continuous press system of claim 11, wherein one or more pressure sensors are utilized at various compression stages in the press system to calculate measurements and said calculations are applied to adjust the angle of the at least one upper belt in relation to the at least one lower belt to facilitate the application of near-continuous symmetrical pressure to the stack to achieve a specific density or thickness of the compressed stack output.

16. A continuous press system of claim 11, wherein one or more platens or bolsters are utilized to apply pressure to the at least one upper belt, to the at least one lower belt, or to the at least one upper belt and at least one lower belt, to compress the stack.

17. A continuous press system of claim 16, wherein one or more pad rollers positioned between the one or more platens or bolsters and the at least one upper belt, and the at least one lower belt.

18. A continuous press system of claim 11, wherein a heat source is incorporated in the press system.

19. A method of compressing a stack through symmetrical pressure comprising the steps of:
(a) inputting a stack between at least one belt and a surface opposingly positioned and relationally angled to produce symmetrical pressure where the distance between the at least one belt and surface is greatest;
(b) directing the stack between the length of the at least one belt and surface by way of movement of the at least one belt, achieved by the application of a power source to a driving means, to move the stack between the belt and surface and exert increasing pressure upon the stack due to the narrowing angle of the at least one belt and surface; and
(c) retrieving the compressed output stack when it exits the length of the opposing at least one belt and surface.

20. A method of compressing of claim 19, having the further step of applying platens or bolsters to exert pressure upon the at least one belt, the surface, or the at least one belt and surface.
